(19) United States
(12) Patent Application Publication
(10) Pub. No.: US 2015/0065256 A1
(43) Pub. Date: Mar. 5, 2015

(54) PLAYER GENERATED CONTENT MANAGEMENT

(71) Applicant: International Business Machines Corporation, Armonk, NY (US)

(72) Inventors: Gary D. Cudak, Creedmoor, NC (US); Lydia M. Do, Raleigh, NC (US); Christopher J. Hardee, Raleigh, NC (US); Adam Roberts, Moncure, NC (US)

(73) Assignee: International Business Machines Corporation, Armonk, NY (US)

(21) Appl. No.: 14/023,245

(22) Filed: Sep. 10, 2013

Related U.S. Application Data
(63) Continuation of application No. 14/017,293, filed on Sep. 3, 2013.

(51) Int. Cl. A63F 13/00

(52) U.S. Cl. CPC A63F 13/00
USPC 463/43

(57) ABSTRACT

Embodiments of the present invention provide a method, system and computer program product for managing player generated content. In an embodiment of the invention, a method for managing player generated content includes recording player generated content for a game playing session into memory of a computer and collecting game metrics for the game playing session during the game playing session. The method also can include comparing the game metrics to one or more pre-stored threshold values. Finally, the method includes determining whether or not to discard the player generated content based upon the comparison and storing in fixed storage of the computer only player generated content determined based upon the comparison not to be discarded.

### BACKGROUND OF THE INVENTION

1. Field of the Invention

The present invention relates to computer gaming and more particularly to player generated content.

2. Description of the Related Art

Computer gaming has always formed a critical end user component of computing and in many ways, has been the impetus for advanced non-gaming technologies—especially in connection with display technologies. A core challenge to the creation of a computer game is the maintenance of the interest level of the end user player so that the end user continues to play the computer game. As such, computer games have become more complex and interesting, and provide many different levels of play, each level presenting more challenging game playing scenarios for the end user player.

Because so many computer games are multi-level and therefore, time consuming, oftentimes, end user players prefer to record portions of player generated content for future review. In this regard, the player generated content can include performance metrics observed during the course of a game playing session, or the entirety of the game playing session as viewed by the end user player, or any combination thereof. For many end users, the recorded player generated content then can be shared over the Internet with other game enthusiasts, or the recorded player generated content can be stored in personal storage for subsequent review and study by the end user player.

Contemporary computer games recognize the trend of player generated content storage and sharing and include in some cases, integrated control mechanisms for recording player generated content during the conduct of a game playing session. As it will be apparent then, to the extent an end user plays many game playing sessions over a period of time, the amount of content recorded can become substantial. In consequence, managing the recorded player generated content can become an administrative challenge. For an individual, managing recorded player generated content can be a tedious exercise, but for the network accessible media sharing service supporting a multiplicity of game players storing player generated content in the cloud, the problem of managing recorded player generated content is acute.

### BRIEF SUMMARY OF THE INVENTION

Embodiments of the present invention address deficiencies of the art in respect to computer gaming and provide a novel and non-obvious method, system and computer program product for managing player generated content. In an embodiment of the invention, a method for managing player generated content includes recording player generated content for a game playing session into memory of a computer and collecting game metrics for the game playing session during the game playing session. The method also can include comparing the game metrics to one or more pre-stored threshold values. Finally, the method includes determining whether or not to discard the player generated content based upon the comparison and storing in fixed storage of the computer only player generated content determined based upon the comparison not to be discarded.

In another embodiment of the invention, a gaming data processing system can be configured for managing player generated content. The system can include a host computing system with at least one computer with memory, fixed storage and at least one processor. The system also can include a game server executing in the memory of the host computing system and managing a game playing session accessible by different end users over a computer communications network. Finally, the system can include a player generated content management module also executing in the memory of the host computing system. The module can include program code enabled during execution in the memory to record player generated content for the game playing session, to collect game metrics for the game playing session, to compare the game metrics to one or more pre-stored threshold values, and to determine whether or not to discard the player generated content based upon the comparison and storing in the fixed storage only player generated content determined based upon the comparison not to be discarded.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for managing player generated content;

FIG. 2 is a schematic illustration of a gaming data processing system configured for managing player generated content; and,

FIG. 3 is a flow chart illustrating a process for managing player generated content.

### DETAILED DESCRIPTION OF THE INVENTION

Embodiments of the invention provide for managing player generated content. In accordance with an embodiment of the invention, player generated content can be recorded during the conduct of a game playing session. Thereafter, one or more metrics of the game playing session can be loaded into memory of a computer and compared to one or more threshold values. Based upon the comparison, it can be determined whether or not to maintain the player generated content in fixed storage, or to remove from fixed storage or otherwise archive the player generated content. In this way, the management of the player generated content can be conducted autonomically without requiring significant intervention by the end user.

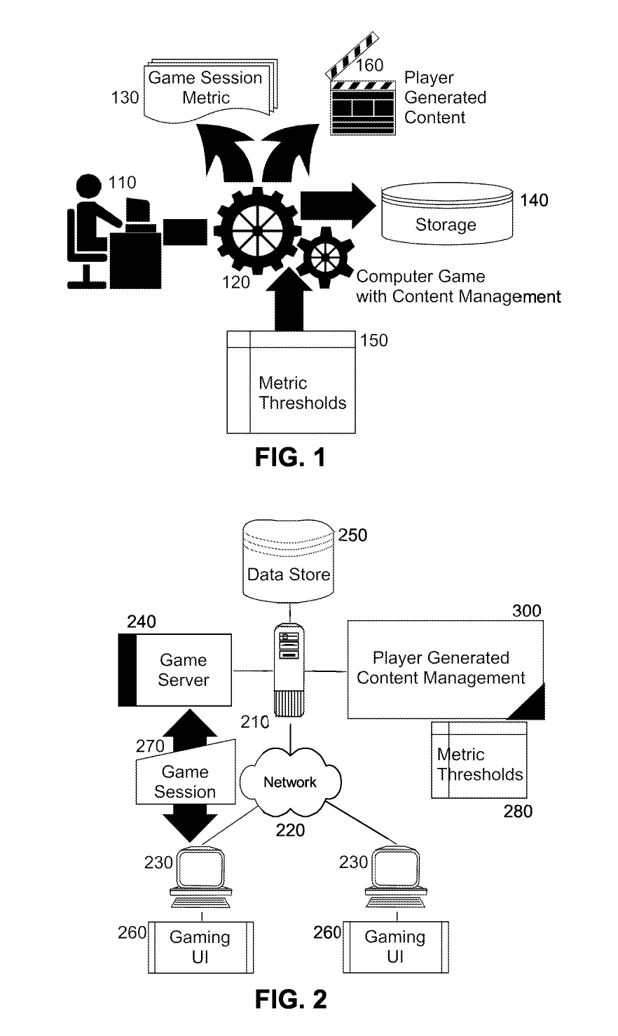

In further illustration, FIG. 1 pictorially shows a process for managing player generated content. As shown in FIG. 1, a game playing end user 110 can play a computer game 120 during which one or more different game session metrics 130 can be produced and stored in fixed storage 140. The game metrics 130 can include by way of example, the performance statistics of the game playing end user 110 such as the score of the game, the amount of experience acquired during the game, different accomplishments or milestones recorded in furtherance of a game goal, a number of hits, kills or deaths and the ratios therebetween, whether or not friendly fire has occurred during the game, accuracy ratios, the time consumed in completing one or more portions of the game, the performance of the game playing end user relative to one or more other game playing end users, and the identity of the other game playing end users.

During the conduct of the computer game 120, player generated content 160 can be recorded. At the conclusion of the session of the computer game playing, the game metrics 130 can be analyzed and compared to one or more corresponding metric thresholds 150. To the extent that the game metrics 130 meet or exceed one or more of the corresponding metric thresholds 150, the computer game 120 can maintain the player generated content 160 in fixed storage 140. Otherwise, the player generated content 160 is removed from fixed storage 140 or otherwise archived. Optionally, the file in the fixed storage 140 storing the player generated content 160 can be provided with at least a portion of a file name that incorporates one or more portions of the game metrics 130.

In further illustration, FIG. 2 schematically illustrates a gaming data processing system configured for managing player generated content. The system can include a host computing system 210 that includes one or more servers each with at least one processor and memory. The system also can include a data store 250 coupled to the host computing system 210. One or more client computers 230 can be communicatively linked to the host computing system 210 by way of computer communications network 220. Each of the client computers 230 can support the operation of a gaming user interface 260 to a computer game session 270 provided by a game server 240 executing in the memory of the host computing system 210.

Player generated content management module 300 can be coupled to the game server 240 and also can execute in the memory of the host computing system 210. The player generated content management module 300 can include program code that when executed in memory of the host computing system 210 is enabled to compare game metrics for the game session 270 to pre-stored metric thresholds 280. For instance, a sum of the game metrics for the game session 270 can be compared to a single pre-stored value, individual ones of the game metrics can be weighted and summed and compared to a single pre-stored value, or individual ones of the game metrics for the game session 270 can be compared to individual corresponding values, to name three examples.

In response to the comparison, for instance in response to one or more of the individual game metrics exceeding the corresponding values of the metric thresholds 280, or in response to a sum—weighted or otherwise—of the game metrics to a single value of the metric thresholds 280, the program code of the of the player generated content management module 300 can retain player generated content for the game session 270 in the data store 250. Otherwise, the program code of the player generated content management module 300 can remove the player generated content from the data store 250 or otherwise archive the player generated content. Optionally, the program code of the player generated content management module 300 can incorporate one or more of the game metrics in a file name for the player generated content.

Optionally, the pre-stored threshold values can be game metrics of a different game playing end user. For instance, the game metrics of the different game playing end user can be extracted from player generated content of the different game playing end user posted in a social media Web site. In response to the collected game metrics exceeding the game metrics of the different game playing end user, the player generated content can be recommended through a prompting for retention in the data store 250. As yet a further option, the player generated content can be recommended through prompting for posting to the social media Web site.

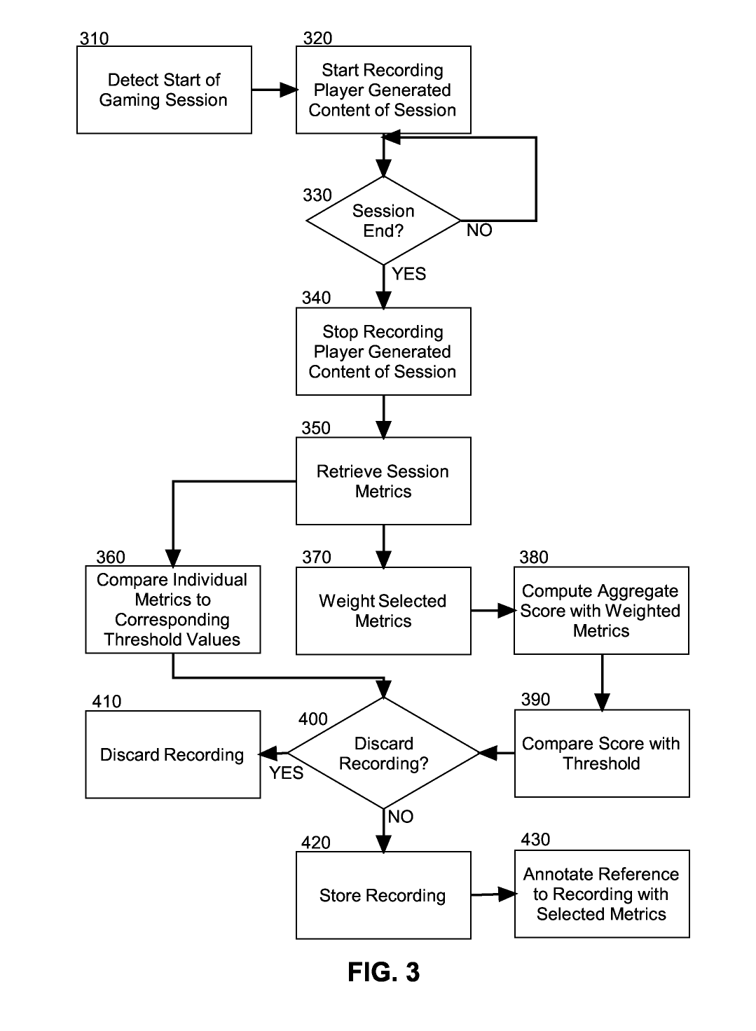

In yet further illustration of the operation of the player generated content management module 300, FIG. 3 is a flow chart illustrating a process for managing player generated content. Beginning in block 310, a start of a game playing session can be detected. In block 320, player generated content such as a recording of a display of the game playing session can be recorded. In decision block 330, if the game playing session is determined to have ended, in block 340, the recording of the player generated content also can end. Thereafter, in block 350 metrics for the game playing session can be retrieved for analysis.

In block 360, individual ones of the metrics can be compared to corresponding pre-stored threshold values. For instance, a speed of completion of a course, or a number of “hits” to a target can be compared to a threshold time of completion for the course, or a threshold number of “hits” to the target, respectively. Alternatively, in block 370 the individual ones of the metrics can be weighted and in block 380 the weighted metrics can be aggregated as to produce an aggregate score to be compared to a threshold score in block 390. In decision block 400, it can be determined whether or not the comparison provides an indication that the game playing session is not notable and therefore should be discarded. If so, in block 410 the player generated content can be discarded. Otherwise, in block 420 the player generated content can be persisted and in block 430, a file name or reference to the player generated content can be computed at least in party based upon the metrics.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radiofrequency, and the like, or any suitable combination of the foregoing. Computer program code for carrying out operations for aspects of the present invention may be written in any combination of one or more programming languages, including an object oriented programming language and conventional procedural programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. In this regard, the flowchart and block diagrams in the Figures illustrate the architecture, functionality, and operation of possible implementations of systems, methods and computer program products according to various embodiments of the present invention. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

1. A method for managing player generated content, the method comprising:
recording player generated content for a game playing session into memory of a computer;
collecting game metrics for the game playing session during the game playing session;
comparing the game metrics to one or more pre-stored threshold values; and,
determining whether or not to discard the player generated content based upon the comparison and storing in fixed storage of the computer only player generated content determined based upon the comparison not to be discarded.

2. The method of claim 1, further comprising naming the player generated content in the fixed storage using at least a portion of the game metrics.

3. The method of claim 1, where individual ones of the game metrics are compared to corresponding ones of the pre-stored threshold values.

4. The method of claim 1, wherein individual ones of the game metrics are weighted and aggregated to produce an aggregate score and the aggregate score is compared to a pre-stored threshold value.

5. The method of claim 1, wherein the game metrics are metrics selected from the group consisting of a score of the game playing session, an amount of experience acquired during the game playing session, different accomplishments or milestones recorded in furtherance of a game goal, a number of hits, kills or deaths and ratios therebetween, whether or not friendly fire has occurred during the game playing session, accuracy ratios, an amount of time consumed in completing one or more portions of the game playing session, a performance of a game playing end user relative to one or more other game playing end users, and an identity of the other game playing end users.

6. The method of claim 1, wherein the player generated content is a recording of the game playing session.

7. The method of claim 1, wherein the pre-stored threshold values are game metrics of a different game playing end user extracted from player generated content of the different game playing end user posted in a social media Web site, and in response to the collected game metrics exceeding the game metrics of the different game playing end user, recommending posting of the player generated content for the game playing session to the social media Web site.

8-20. (canceled)
